(19) United States
(12) Patent Application Publication
(10) Pub. No.: US 2018/0201115 A1
(43) Pub. Date: Jul. 19, 2018

(54) HYBRID VEHICLE

(71) Applicant: IFP Energies Nouvelles, Rueil-Malmaison Cedex (FR)

(72) Inventor: Stephane VENTURI, Roiffieux (FR)

(73) Assignee: IFP Energies Nouvelles, Rueil-Malmaison Cedex (FR)

(21) Appl. No.: 15/745,812

(22) PCT Filed: Jul. 18, 2016
(86) PCT No.: PCT/EP2016/067010

§ 371 Date: Jan. 18, 2018

(30) Foreign Application Priority Data
Jul. 20, 2015 (FR) 1556854

(51) Int. Cl. B60K 6/365; B60K 6/387; B60K 6/48; F16H 3/72

(52) U.S. Cl. CPC B60K 6/365; B60K 6/387; B60W 10/115; F16H 3/725; B60K 6/48

(57) ABSTRACT

A hybrid vehicle, including first and second drive motors, an axle driven by the first and/or second drive motor, a mechanical transmission connecting the axle to the first and second drive motors. The transmission includes a planetary gear train having two reduction ratios between the second drive motor and the axle, and including a switching mechanism imposing each of the reduction ratios. The switching mechanism includes a first mechanism configured to rigidly connect and disconnect two components of the planetary gear train, and a second mechanism configured to halt and release a third component of the planetary gear train, the second mechanism is located on a portion of the transmission located between the planetary gear train and the first drive motor, the portion of the transmission is another planetary gear train, and the second mechanism is a coupling having two coupling states, including a state of blocking the other train.

The subject matter of the present invention is a hybrid vehicle in which a torque rupture elimination is performed during mode changes in the simple propelling regime. One aspect of the invention is the vehicle itself, and another aspect is the method associated therewith.

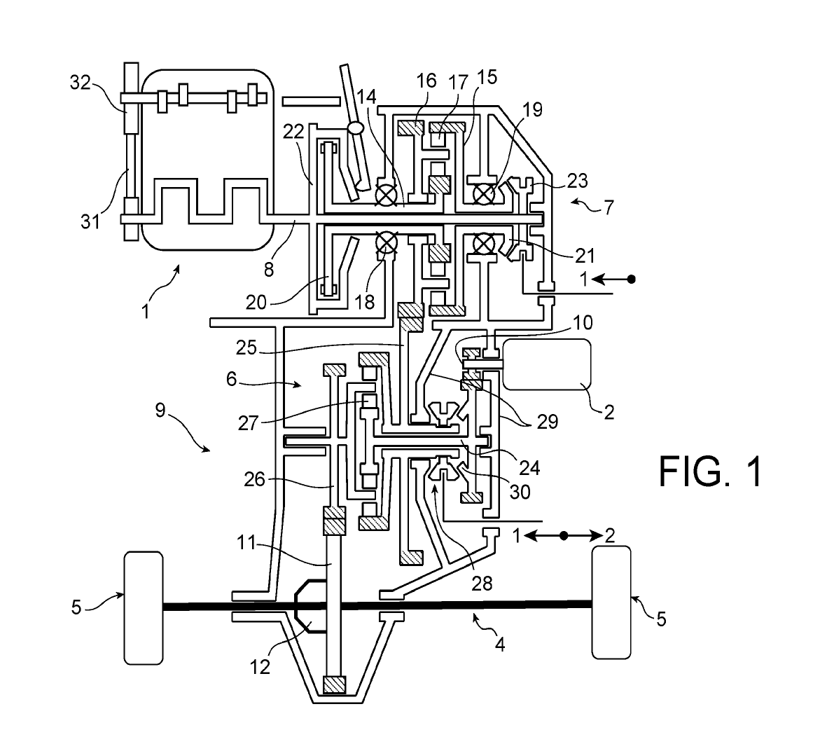

A particular embodiment of hybrid vehicle will be now described by means of FIG. 1. It comprises a thermal engine 1, which is a first prime mover, and an electric motor 2, which is a second prime mover. Other kinds of prime movers could be contemplated, and thus the electric motor 2 could be replaced by a hydraulic or pneumatic machine.

The power delivered by the prime movers is transmitted to a powered axle 4, provided with wheels 5 by which the vehicle is driven, by means of a transmission 6 which will be briefly described. It includes a first planetary gearset 7, moved by the output shaft 8 of the thermal engine 1, and a second planetary gearset 9, which will be described in more detail here and which is driven by the drive shaft 10 of the electric motor 2 and/or by the first planetary gearset. An output sprocket wheel 11 is directly driven by the second planetary gearset 9 and is connected to the axle 4 by a differential 12. The first planetary gearset 7 drives the axle 4 through the second planetary gearset 9, the planetary gearsets 7 and 9 being thus in series and the first planetary gearset 7 being possibly considered as a branch of the transmission 6 connecting the second planetary gearset 9 to the thermal engine 1.

Driving such hybrid vehicles can be made in the hybrid regime, or conversely by preferentially or exclusively resorting to either of the prime movers: the electric motor 2 will be rather used in town to limit noise and pollution, and the thermal engine 1 on the road to give higher speeds and take advantage of a greater autonomy as well.

Some operating characteristics of the vehicle are given herein below; more detail is given in document WO 2015/071088 A, to which it is referred to if need be, given that the invention could be applied to different vehicles, both from the embodiment described herein and the embodiments described in this previous document.

A hybrid vehicle is described in WO 2012/007661, which seems to be the prior art closest to the invention.

The planetary gearsets 7 and 9 enable different speed reducing ratios to be imposed between each of the prime movers and the axle 4 by means of different operating states. Thus, the first planetary gearset 7 includes a sun gear 14 with a hollow shaft in which the output shaft 8 is engaged, a ring gear 15 also with a hollow shaft in which the output shaft 8 is engaged, and a planet carrier 16, which makes up an output device of the planetary gearset 7 and conventionally meshes, through planet gears 17 it carries, with gear teeth dug on the sun gear 14 and the ring gear 15. The hollow shafts are restricted to unidirectional rotations by free wheel devices 18 and 19. The elements of the transmission 6, as well as the prime movers and the axle 4, are held on or in a frame 29.

The hollow shafts are provided with flanges, respectively 20 and 21, for engaging with respective controlled couplings 22 and 23 including movable portions, rotatably driven by the output shaft 8 but sliding on the same, and control mechanisms to govern these sliding movements. The abovementioned document explains that different rotation speed ratios between the output shaft 8 and the planet carrier 16 can be controlled by engaging the coupling 22, which secures the sun gear 14 with the output shaft 8, or the coupling 23, which secures the ring gear 15 with the output shaft 8, or both simultaneously, which blocks the planetary gearset 7 and makes it completely integral with the output shaft 8. And if both couplings 22 and 23 are released, the first planetary gearset 7 is free.

The second planetary gearset 9 comprises a sun gear 24 driven by the electric motor 2, a ring gear 25 meshing with the planet carrier 16 of the first planetary gearset 7 and a planet carrier 26, meshing on the one hand with the output sprocket wheel 11 by external teeth, and on the other hand with the sun gear 24 and internal teeth of the ring gear 25 by planet gears 27. A third controlled coupling 28 is provided. It comprises a movable element driven by the ring gear 25 and able to secure it, in a first end state, with the frame 29, and in another end state with a flange 30 of the sun gear 24. In the first end state, the sun gear 24 thus rotates the planet carrier 26 through the planet gears 27, whereas the ring gear 25 is stationary; in the second end state, the planetary gearset 9 is blocked and the planet carrier 26 rotates at the same rotation speed as the sun gear 24; and in the intermediate state, the rotation speed of the planet carrier 26 depends both on that of the sun gear 24 and that of the ring gear 25, imposed by a possible operation of the thermal engine 1. The first end state corresponds to a short electric mode, with a large speed reducing ratio, the second end state to a long electric mode, with a more reduced speed reducing ratio between the output shaft 10 of the electric motor 2 and the axle 4, and the intermediate state to a so-called “power split” regime.

In the long electric mode, the thermal engine can also be used, this corresponds to a use in the parallel hybrid mode.

The technical problem underlying the invention is now set out. When the thermal engine 1 is stopped and inactive in the purely electrical propelling regime, and when a switching from the short electric mode to the long electric mode is requested to the electric motor 2, the following phenomenon occurs. The movable element of the third coupling 28 is disengaged from the frame 29 and releases the ring gear 25. The engagement of the movable element of the third coupling 28 with the flange 30 is however possible only when their rotation speeds have been synchronised. Since the axle 4 continues to rotate approximately at the same speed during this switching, the electric motor 2 has to decelerate. The ratio of the speed reducing ratios is generally significant, in the order of about 3, and the deceleration is thus dramatic. The torque transmitted by the electric motor 2 to the axle 4 should thus be eliminated during this synchronisation phase of the regimes during switching, which prevents the driver from accelerating as he/she would have wanted, and can yield an uncomfortable driving. This torque rupture, undergone to the long electric mode, also exists, as an opposite rupture (abrupt and significant increase) which is also uncomfortable, in switchings from the long electric mode to the short electric mode.

With the invention, this technical problem is obviated, thanks to a smart choice of the coupling system ensuring a quicker switching between both speed reducing ratios or modes of the electric motor 2, or more generally of one of the prime movers, which reduces or removes the intermediate state of this “power split” where the torque rupture is sensitive.

Another advantage of the invention is that the modified coupling system generally allows a parking brake state, by fully blocking the transmission upon stopping the prime movers.

In a general form, it consists of a hybrid vehicle, comprising a first prime mover, a second prime mover, an axle driven by the first prime mover and/or the second prime mover, a mechanical transmission connecting the axle to the first prime mover and to the second prime mover, the transmission comprising a planetary gearset with two speed reducing ratios between the second prime mover and the axle, the planetary gearset comprising a switching mechanism to impose each of the speed reducing ratios, where the switching mechanism is divided in two and comprises a first mechanism able to secure and unsecure two components of the planetary gearset, and a second mechanism able to stop and release a third component of the planetary gearset, the second mechanism is located on a part of the transmission located between the planetary gearset and the first prime mover, said part of the transmission is another planetary gearset, characterised in that the second mechanism is a coupling with two coupling states, including a state of blocking said other gearset.

A properly synchronised action on both mechanisms replacing the unit mechanism of a known design enables the switching time during which the so-called “power split” mode, during which the torque rupture prevails, is exerted, to be substantially reduced or removed. The electric ratio changes are thus much less sensitive for the driver.

By choosing a second mechanism as a coupling with two states acting on another planetary gearset, the device is prevented from being too strongly complicated, since rather than replacing the switching mechanism with two mechanisms associated with the planetary gearset in question, it is chosen to stop the third component by an already existing mechanism on the other planetary gearset to control two states therein, by only slightly complicating this mechanism to assign it another coupling state. The advantages of the invention are thus moderate cost and overall space for the device.

For the purposes of the invention, blocking the other planetary gearset completed by the second mechanism is a rotation stop of at least one component of this other gearset, in a state where other mechanisms can intervene to block or secure other components of the other gearset and of the transmission, and thus achieving blocking said other gearset in combination with the second mechanism.

The invention thus designed can be implemented in many ways. Therefore, there is a freedom in choosing components connected by the first mechanism, and the component on which the second mechanism acts. Both components of the first mechanism can thus, according to an actually suggested embodiment for the invention, comprise the sun gear and the ring gear, the sun gear and the planet carrier, or the ring gear and the planet carrier.

The first mechanism can be a clutch, instead of a synchroniser, as is proposed in the known embodiment.

The different aspects, characteristics and advantages of the invention will now be described in more detail, by means of the following figures, appended by way of purely illustrating purposes:

FIG. 1 illustrates a known hybrid vehicle;

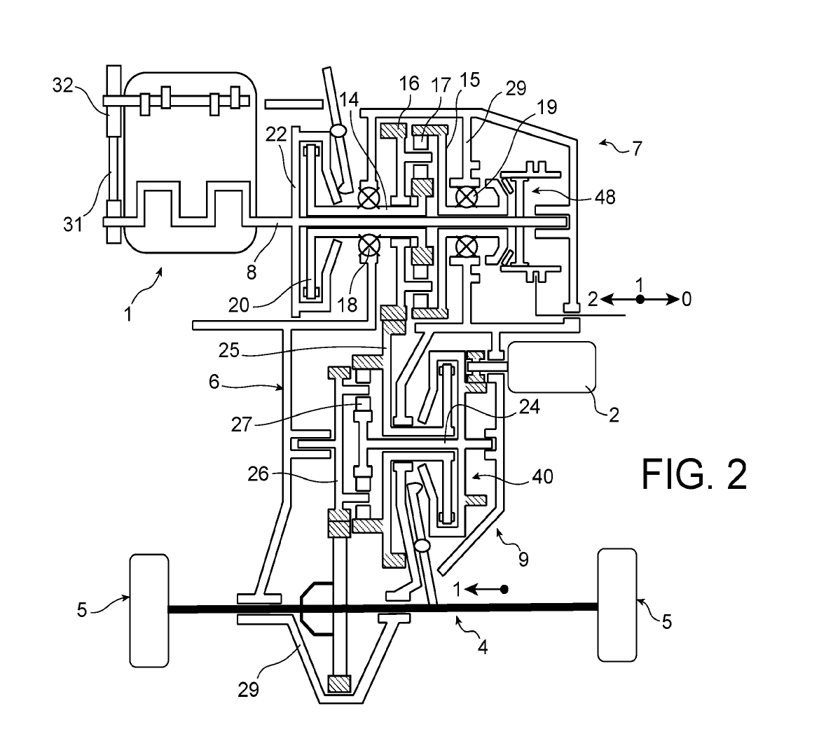

and FIGS. 2, 3 and 4 illustrate one embodiment of the invention with three operating states;

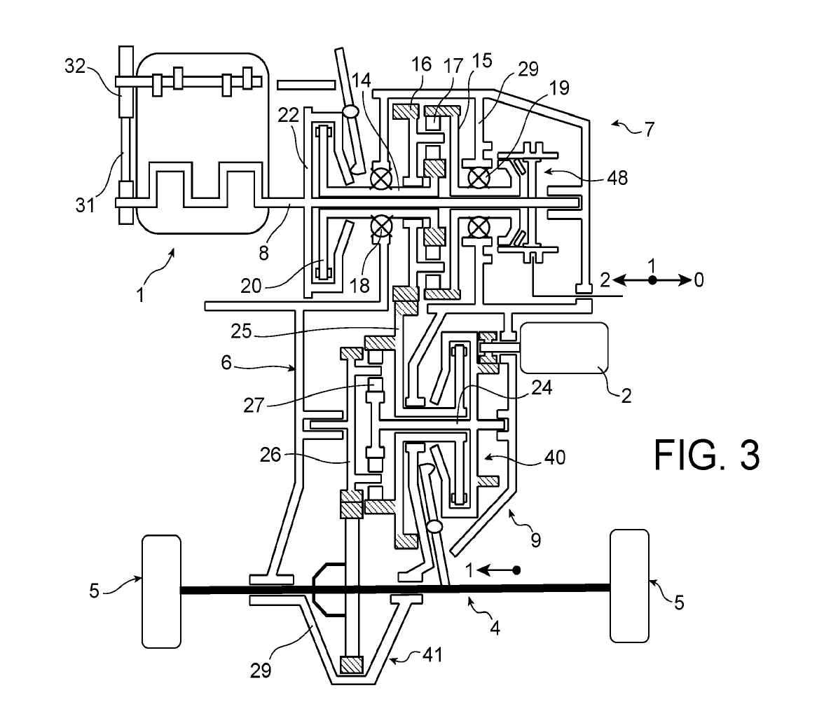

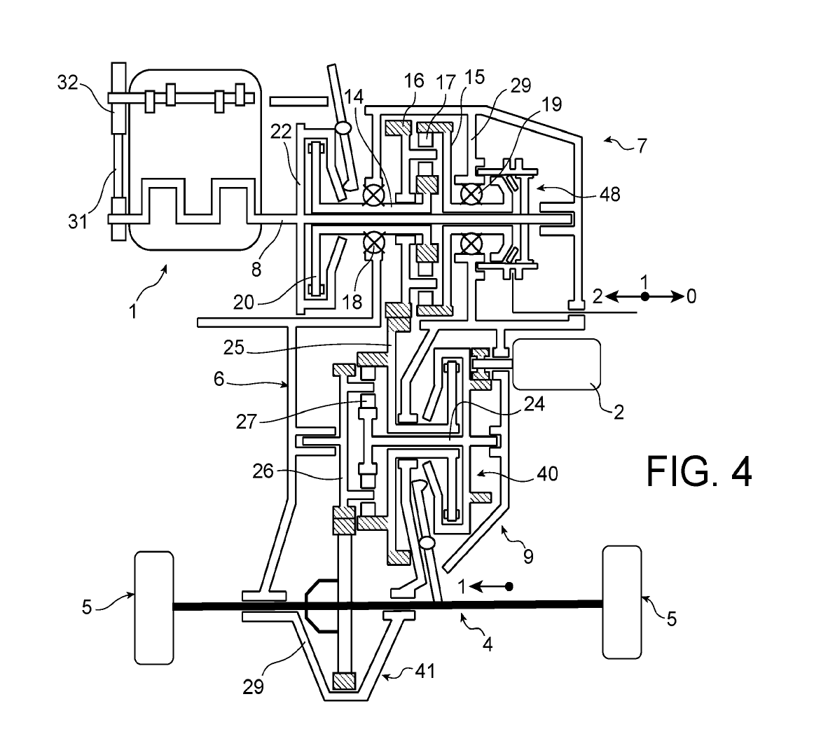

FIGS. 2, 3 and 4 represent one embodiment of the invention, which includes a clutch 40 between the sun gear 24 and the ring gear 25 in place of the third coupling 28, whereas the coupling 23 of the embodiment of FIG. 1 is replaced with a coupling 48 with three positions. In the state of FIG. 2, the coupling 48 does not make any securement; in the intermediate state, represented in FIG. 3, it secures the output shaft 8 of the thermal engine 1 with the ring gear 15 of the first planetary gearset 7; and in the state of FIG. 4, which has no equivalent in FIG. 1, it locks the output shaft 8 and the ring gear 15 to the frame 29, and consequently, it also blocks the ring gear 25 of the second planetary gearset 9. The full blocking of the first planetary gearset 7 is thus achieved in both rotation directions when the sun gear 14 and the shaft 8 are coupled by means of the clutch 22, which enables energy to be recovered by the electric motor 2 during deceleration phases, as well as the use of reverse gear.

Switching from the short electric ratio to the long electric ratio is made, the thermal engine 1 being idle, by closing the clutch 40 while placing the coupling 48 in the free state of FIG. 62, which releases the ring gear 25 and immediately secures it to the sun gear 24. The regime of the electric motor 2 decreases at the same time as the rotation speed of the ring gear 25 increases. A proper synchronisation of the switchings of both mechanisms essentially removes the “power split” state obtained in the free state of the second planetary gearset 9, and thus the torque rupture.

To achieve switching from the long ratio to the short electric ratio, the same steps are carried out in the reverse order. A proper synchronisation of the mechanism switchings enables the duration of the transitory mode and the uncomfortable sensation felt by the driver to be further reduced. As soon as the clutch 40 is open, the regime of the ring gear 25, which then drives the first planetary gearset 7, decreases before being eliminated and being blocked in front of the frame 29, by virtue of the action of the free wheels 18 and 19, which prevent the rotation in the reverse direction of the first planetary gearset 7. When this situation is reached, it is possible to actuate the coupling 48 to place it in the state of FIG. 4, which makes the ring gear 25 stationary in both rotation directions, while allowing energy recovery by the electric motor 2 during decelerations, as well as the use of the reverse gear. The synchronisation of the mechanisms is ensured by setting the control system of the vehicle. Switching from the long mode to the short mode is however not allowed during a deceleration. To achieve a parking brake, the coupling 48 has to be placed in the position of FIG. 4 and the other couplings should also be engaged.

And if the coupling 48 is in the position of FIG. 4, the actuation of other couplings 22 and 40 enables electric ratios to be changed between the short one and the long one, as well as during acceleration and deceleration phases.

Starting the thermal motor 21 is however not possible in this state of FIG. 4.

Likewise, the embodiment of FIGS. 2 to 4 could be applied with synchronisers on the first planetary gearset 7. Finally, the position of the actuator 48 and of the other coupling could be reversed on the first planetary gearset 7, so as to fully block the sun gear 14 and the output shaft 8 to the case 29. Blocking the ring gear 15 would remain possible by engaging the coupling 23.

1-9. (canceled)

10. A hybrid vehicle, comprising:
a first prime mover;
a second prime mover;
an axle driven by the first prime mover and/or the second prime mover;
a mechanical transmission connecting the axle to the first prime mover and to the second prime mover, the transmission comprising a planetary gearset with two speed reducing ratios between the second prime mover and the axle, the planetary gearset comprising a switching mechanism to impose each of the speed reducing ratios, wherein the switching mechanism is divided in two and comprises a first mechanism configured to secure and unsecure two components of the planetary gearset, and a second mechanism configured to stop and release a third component of the planetary gearset, the second mechanism is located on a part of the transmission located between the planetary gearset and the first prime mover, the part of the transmission is another planetary gearset,
wherein the second mechanism is a coupling with two coupling states, including a state of blocking the other gearset.

11. The hybrid vehicle according to claim 10, wherein the third component of the planetary gearset is also one of the two components.

12. The hybrid vehicle according to claim 11, wherein the third component of the planetary gearset is a ring gear of the gearset.

13. The hybrid vehicle according to claim 11, wherein both components of the planetary gearset include a sun gear of the planetary gearset.

14. The hybrid vehicle according to claim 11, wherein both components of the planetary gearset include a ring gear of the gearset.

15. The hybrid vehicle according to claim 11, wherein the first mechanism is a clutch.

16. The hybrid vehicle according to claim 11, wherein both coupling states of the second mechanism also comprise a state of securing both components of the transmission, including at least one component of the other planetary gearset.

17. The hybrid vehicle according to claim 11, wherein the state of blocking the other gearset stops rotation of the two components of the transmission.

18. The hybrid vehicle according to claim 11, wherein the first prime mover is a thermal engine, the second prime mover is an electric motor, the planetary gearset is driven both by the other planetary gearset and the second prime mover, and the other planetary gearset is driven by the first prime mover.

19. The hybrid vehicle according to claim 10, wherein the third component of the planetary gearset is a ring gear of the gearset.

20. The hybrid vehicle according to claim 10, wherein both components of the planetary gearset include a sun gear of the planetary gearset.

21. The hybrid vehicle according to claim 10, wherein both components of the planetary gearset include a ring gear of the gearset.

22. The hybrid vehicle according to claim 10, wherein the first mechanism is a clutch.

23. The hybrid vehicle according to claim 10, wherein both coupling states of the second mechanism also comprise a state of securing both components of the transmission, including at least one component of the other planetary gearset.

24. The hybrid vehicle according to claim 10, wherein the state of blocking the other gearset stops rotation of the two components of the transmission.

25. The hybrid vehicle according to claim 10, wherein the first prime mover is a thermal engine, the second prime mover is an electric motor, the planetary gearset is driven both by the other planetary gearset and the second prime mover, and the other planetary gearset is driven by the first prime mover.
